(19) United States
(12) Patent Application Publication
(10) Pub. No.: US 2026/0235411 A1
(43) Pub. Date: Aug. 13, 2026

(54) RELATIVE POSE ESTIMATION BASED ON OPPORTUNISTIC REFERENCE COORDINATE SYSTEM

(71) Applicant: QUALCOMM Incorporated, San Diego, CA (US)

(72) Inventors: Stelios STEFANATOS, San Diego, CA (US); Anantharaman BALASUBRAMANIAN, San Diego, CA (US); Kapil GULATI, Belle Mead, NJ (US); Dan VASSILOVSKI, Del Mar, CA (US)

(21) Appl. No.: 19/471,004

(22) PCT Filed: May 17, 2024
(86) PCT No.: PCT/US2024/029990

§ 371 Date: Sep. 30, 2025

(30) Foreign Application Priority Data
Jun. 1, 2023 (GR) 20230100436

(51) Int. Cl. G01C 21/28; B60W 60/00; G06T 7/73; H04W 4/46

(52) U.S. Cl. CPC G01C 21/28; G06T 7/74; H04W 4/46; B60W 60/001; B60W 2420/403; B60W 2554/802; B60W 2556/65; G06T 2207/30252

(57) ABSTRACT

An example method of relative pose estimation for autonomous vehicle navigation performed by a first User Equipment (UE) associated with a first vehicle may comprise obtaining by a camera at the first vehicle, an image of a reference object observable to the camera and determining a first relative pose of the first vehicle with respect to a reference coordinate system associated with the reference object using the image. The method may comprise transmitting to a second UE associated with a second vehicle, a request message configuring the second UE to transmit a response message indicating a second relative pose of the second vehicle with respect to the reference coordinate system and determining a third relative pose estimate of the first vehicle with respect to the second vehicle using the first relative pose of the first vehicle and the second relative pose of the second vehicle.

### RELATED APPLICATIONS

This application claims the benefit of Greek application No. 20230100436, filed Jun. 1, 2023, entitled “RELATIVE POSE ESTIMATION BASED ON OPPORTUNISTIC REFERENCE COORDINATE SYSTEM,” which is assigned to the assignee hereof, and incorporated herein in its entirety by reference.

### BACKGROUND

### 1. Field of Disclosure

The present disclosure relates generally to the field of autonomous driving and more specifically to a method of relative pose estimation for autonomous vehicle navigation based on opportunistic reference coordinate system.

### 2. Description of Related Art

The demand for advanced driver assistance systems (ADAS) and autonomous driving has increased in recent years due to the growing need for safer and more efficient transportation. One of the key factors for the success of such systems is the ability to accurately perceive and understand the surrounding driving environment. This involves the acquisition of information regarding the position and velocity of other vehicles on the road, which is crucial for tasks such as planning future paths, avoiding collisions, and implementing emergency maneuvers. The importance of this information has led to the development of standardized basic safety messages (BSM) that can be transmitted over the air. These BSMs contain data such as position and velocity, along with other important information about the driving environment.

### BRIEF SUMMARY

An example method of relative pose estimation for autonomous vehicle navigation performed by a first User Equipment (UE) associated with a first vehicle may comprise obtaining by a camera at the first vehicle, an image of a reference object observable to the camera and determining a first relative pose of the first vehicle with respect to a reference coordinate system associated with the reference object using the image. The method may comprise transmitting to a second UE associated with a second vehicle, a request message configuring the second UE to transmit a response message indicating a second relative pose of the second vehicle with respect to the reference coordinate system and determining a third relative pose estimate of the first vehicle with respect to the second vehicle using the first relative pose of the first vehicle and the second relative pose of the second vehicle. The method may comprise outputting the third relative pose estimate for autonomous vehicle navigation of the first vehicle.

An example User Equipment (UE) for relative pose estimation for autonomous vehicle navigation, wherein the UE is associated with a first vehicle, and wherein the UE comprises a transceiver, a memory, and one or more processors communicatively coupled with the transceiver and the memory. The one or more processors may be configured to obtain by a camera at the first vehicle, an image of a reference object observable to the camera. The one or more processors may be configured to determine a first relative pose of the first vehicle with respect to a reference coordinate system associated with the reference object using the image. The one or more processors may be configured to transmit to a second UE associated with a second vehicle, a request message configuring the second UE to transmit a response message indicating a second relative pose of the second vehicle with respect to the reference coordinate system. The one or more processors may be configured to determine a third relative pose estimate of the first vehicle with respect to the second vehicle using the first relative pose of the first vehicle and the second relative pose of the second vehicle. The one or more processors may be configured to output the third relative pose estimate for autonomous vehicle navigation of the first vehicle.

An example apparatus for relative pose estimation for autonomous vehicle navigation, the apparatus may comprise means for obtaining by a camera at a first vehicle associated with the apparatus, an image of a reference object observable to the camera. The apparatus may comprise means for determining a first relative pose of the first vehicle with respect to a reference coordinate system associated with the reference object using the image. The apparatus may comprise means for transmitting to a second UE associated with a second vehicle, a request message configuring the second UE to transmit a response message indicating a second relative pose of the second vehicle with respect to the reference coordinate system. The apparatus may comprise means for determining a third relative pose estimate of the first vehicle with respect to the second vehicle using the first relative pose of the first vehicle and the second relative pose of the second vehicle. The apparatus may comprise means for outputting the third relative pose estimate for autonomous vehicle navigation of the first vehicle.

An example non-transitory computer-readable medium storing instructions for relative pose estimation for autonomous vehicle navigation, the instructions may comprise code for obtaining by a camera at the first vehicle, an image of a reference object observable to the camera. The instructions may comprise code for determining a first relative pose of the first vehicle with respect to a reference coordinate system associated with the reference object using the image. The instructions may comprise code for transmitting to a second UE associated with a second vehicle, a request message configuring the second UE to transmit a response message indicating a second relative pose of the second vehicle with respect to the reference coordinate system. The instructions may comprise code for determining a third relative pose estimate of the first vehicle with respect to the second vehicle using the first relative pose of the first vehicle and the second relative pose of the second vehicle. The instructions may comprise code for outputting the third relative pose estimate for autonomous vehicle navigation of the first vehicle.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a drawing of a perspective view of a vehicle.

FIG. 2 is a block diagram of a position estimation system, according to an embodiment.

FIG. 3 is a diagram showing an example of how relative pose estimation for autonomous vehicle navigation may be performed based on opportunistic reference coordinate system, according to some embodiments.

FIG. 4 is a call diagram showing an example of how relative pose estimation for autonomous vehicle navigation may be performed among different UEs, according to some embodiments.

FIG. 5 is a flow diagram of a method of relative pose estimation for autonomous vehicle navigation based on opportunistic reference coordinate system, according to an embodiment.

FIG. 6 is a block diagram of an embodiment of a UE, which can be utilized in embodiments as described herein.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

Several illustrative embodiments will now be described with respect to the accompanying drawings, which form a part hereof. The ensuing description provides embodiment(s) only, and is not intended to limit the scope, applicability, or configuration of the disclosure. Rather, the ensuing description of the embodiment(s) will provide those skilled in the art with an enabling description for implementing an embodiment. It is understood that various changes may be made in the function and arrangement of elements without departing from the scope of this disclosure.

As used herein, the term “position estimate” of a vehicle is an estimation of the location of the vehicle within a frame of reference. This can mean, for example, an estimate of vehicle location on a 2D coordinate frame (e.g., latitude and longitude on a 2D map, etc.) or within a 3D coordinate frame (e.g., latitude, longitude, and altitude (LLA) on a 3D map), and may optionally include orientation information, such as heading. In some embodiments, a position estimate may include an estimate of six degrees of freedom (6-DOF) (also known as “pose”), which includes translation (latitude, longitude, and altitude) and orientation (pitch, roll, and yaw) information.

As used herein, the term ‘pose estimate’ may refer to an estimation of the position and orientation of the vehicle within a frame of reference. The orientation component of the pose estimate may be represented in different ways, such as a 3×3 matrix or as 3 elements using an ‘axis-angle’ representation of rotation. In some embodiments, the rotation matrix may be reported as 9 real-valued elements or as a set of 3 vectors representing the orthonormal basis of the rotated frame.

It can be noted that, although embodiments described herein below are directed toward determining the relative pose of a vehicle, embodiments are not so limited. Alternative embodiments, for example, may be directed toward other mobile devices and/or applications in which relative pose determination is made. A person of ordinary skill in the art will recognize many variations to the embodiments described herein.

As noted, the accurate knowledge of the driving environment is crucial for automotive safety as well as ADAS applications. The position and velocity of other vehicles on the road are critical pieces of information for tasks such as planning future paths, avoiding collisions, and implementing emergency maneuvers. These parameters are already part of standardized BSMs transmitted over the air, but reliable message delivery at least depends on the assumptions that 1. the messages are frequently transmitted and received, and 2. vehicles know their position accurately. However, these assumptions may not be valid under congested conditions (e.g., where many transmissions occur over limited resources leading to collisions among the message transmissions) or in areas with poor or no GPS coverage (e.g., in tunnels). To overcome these limitations, an alternative or additional method is needed for vehicles to communicate their positions.

Existing methods for communicating positions among multiple vehicles use vehicles' absolute coordinates (such as GNSS coordinates) for identifying the driving environment for the multiple vehicles. However, from a single vehicle's perspective, the absolute coordinates of another vehicle may not be of interest. Instead, it may be more useful to know the position and orientation (also referred to as “pose”) of the other vehicle relative to its own position. For instance, a vehicle only needs to know the distance and orientation (velocity vector) of another vehicle relative to its own position for understanding the surrounding driving environment of the vehicle. The absolute coordinates of the two vehicles are not necessarily needed for this purpose.

Various aspects relate generally to autonomous driving. Some aspects more specifically relate to relative pose estimation for autonomous vehicle navigation based on opportunistic reference coordinate system. In some examples, a first UE associated with a first vehicle may obtain images of one or more reference objects using a camera at the first vehicle and may determine a first set of relative poses of the first vehicle with respect to reference coordinate systems associated with the one or more reference objects using the images. The first UE may transmit to a second UE associated with a second vehicle, a request message configuring the second UE to transmit a response message indicating a second set of relative poses of the second vehicle with respect to one or more of the reference coordinate systems. The first vehicle may then determine the relative pose estimate of the first vehicle with respect to the second vehicle using the first set of relative poses of the first vehicle and the second set of relative poses of the second vehicle. The relative pose estimate of the first vehicle with respect to the second vehicle may be output for autonomous vehicle navigation of the first vehicle.

Particular aspects of the subject matter described in this disclosure can be implemented to realize one or more of the following potential advantages. In some examples, by determining the relative pose estimate with surrounding vehicles using opportunistic reference coordinate system, the technical solution disclosed herein may improve reliability, enhance safety, increase efficiency of the automotive safety and/or ADAS applications. In addition, the vehicles might only calculate and convey their rotation/translation to determine their relative positioning as required (e.g., on a need-to-know basis), rather than indiscriminately broadcasting their absolute location. This can be done even without the necessity of knowing their absolute position. Accordingly, performing the technical solution disclosed herein can also lead to better planning and decision-making in various applications, such as route planning, fleet management, autonomous driving, and/or ADAS applications.

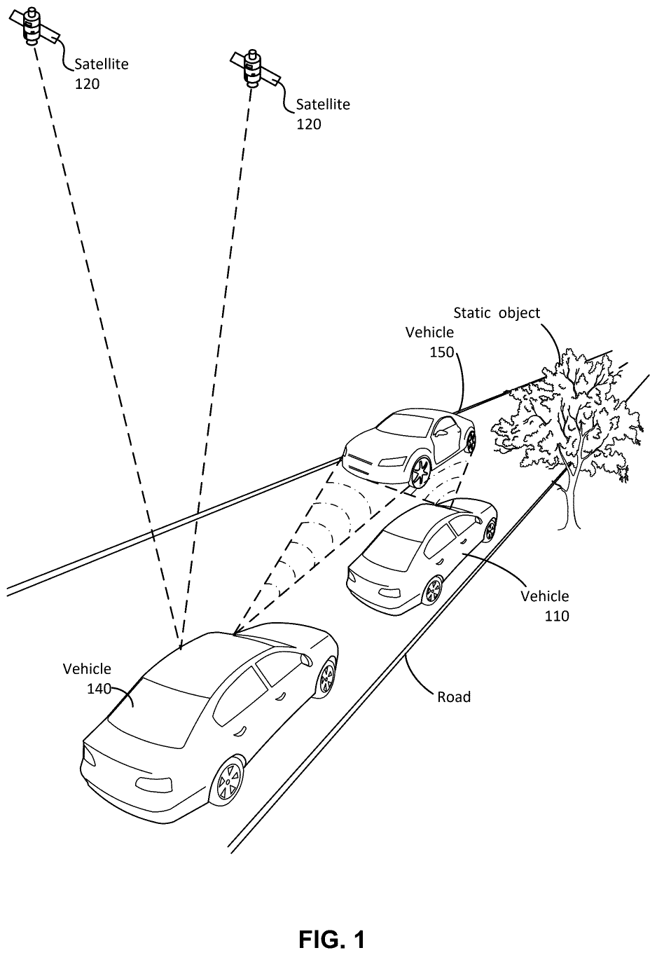

FIG. 1 is a drawing of a perspective view of a vehicle 110, illustrating how vehicle 110 may obtain knowledge of driving environment for ADAS and/or autonomous driving applications. In existing technical solutions, the vehicle 110 may first determine its position (e.g., an absolute position based on GPS), then obtain information of objects within a vicinity of vehicle 110 (e.g., position and velocity (speed) of neighboring vehicles determined based on knowledge of absolute positions of the objects) through e.g., standardized BSM transmitted over the air. ADAS and/or autonomous driving applications may then be performed based on the information of the objects within the vicinity of vehicle 110.

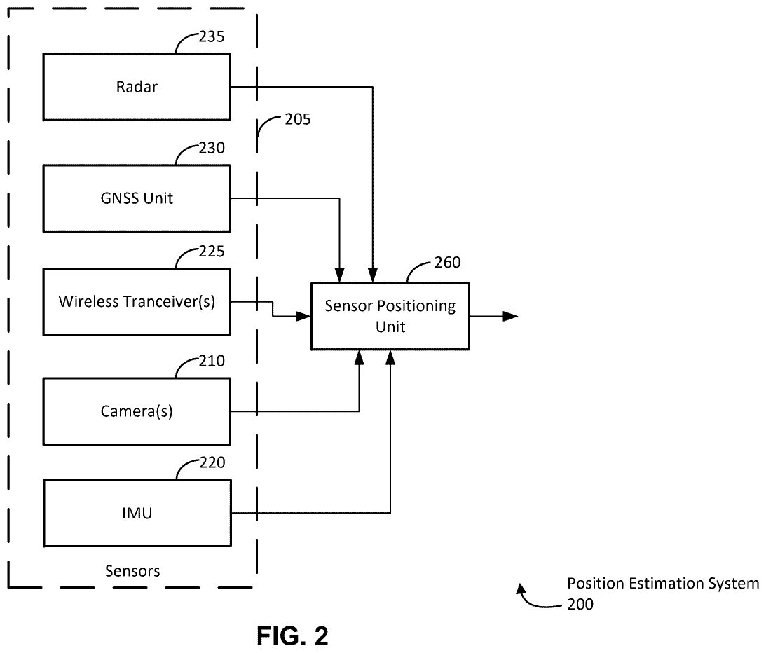

For example, positioning (e.g., determining the absolute position) may be performed using a GNSS receiver at vehicle 110 to receive radio frequency (RF) signals transmitted by GNSS satellites 120. (Of course, although satellites 120 in FIG. 1 are illustrated as relatively close to vehicle 110 for visual simplicity, it will be understood that satellites 120 will be in orbit around the earth. Moreover the satellites 120 may be part of a large constellation of satellites of a GNSS system. Additional satellites of such a constellation are not shown in FIG. 1.) Additionally or alternatively, the terrestrial positioning may be performed using RF signals from terrestrial beacons are transceivers, such as base stations from a cellular communication network. Vehicle sensors and an HDD map may also be used to help determine an accurate position of the vehicle 110. (Additional details regarding how these different components can be used for positioning are provided with regard to FIG. 2). The position of vehicle 110 may be used for purposes such as vehicle maneuvering, navigation, and so forth.

Additionally or alternatively, as will be disclosed in detail below, vehicle 110 may also perform ADAS and/or autonomous driving applications by determining relative pose(s) (e.g., including the relative position and orientation of vehicle 110) with respect to other vehicle(s) 140 in the vicinity of vehicle 110 (e.g., within a predetermined range of vehicle 110) based on using reference coordinate system(s) associated with opportunistic reference object(s) (e.g., vehicle 150) visible/observable to both vehicles 110 and 140. Performing the technical solution disclosed herein may improve reliability, enhance safety, increase efficiency of the automotive safety and/or ADAS applications. In addition, the vehicles might only calculate and convey their rotation/translation to determine their relative pose estimate as required (e.g., on a need-to-know basis), rather than indiscriminately broadcasting their absolute locations. This can be done even without the necessity of knowing their absolute positions.

FIG. 2 is a block diagram of a position estimation system 200, according to an embodiment. Position estimation system 200 may collect data from various different sources and may output position estimates of the vehicle. As will be disclosed in detail below, position estimation system 200 may also be used for determining relative pose estimate of the vehicle with respect to an opportunistic reference coordinate system. This position and/or relative pose estimate can be used by an automated driving system, ADAS system, and/or other systems on the vehicle, as well as systems (e.g., traffic monitoring systems) remote to the vehicle.

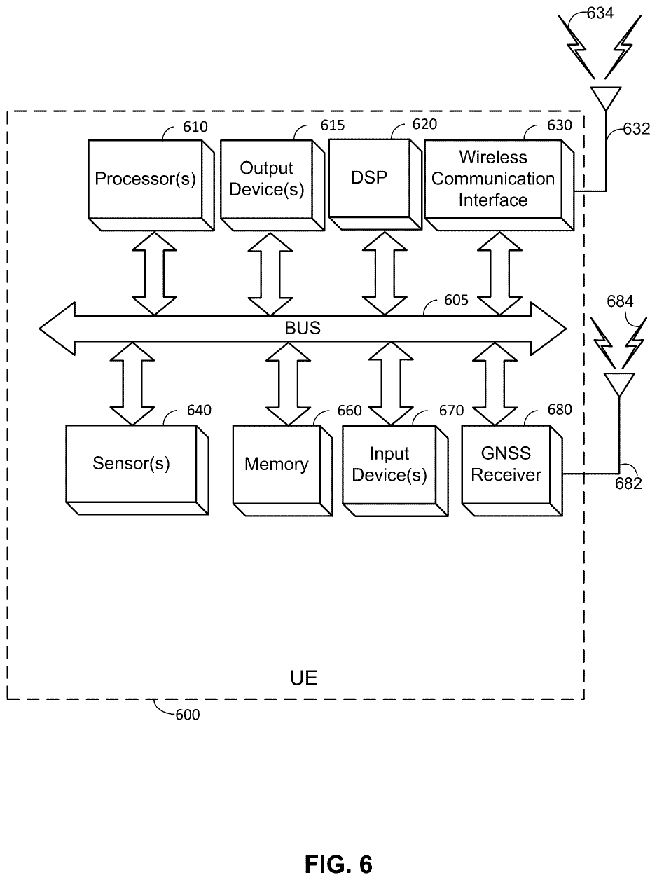

In some embodiments, position estimation system 200 comprises sensors 205 including one or more cameras 210, an inertial measurement unit (IMU) 220, a GNSS unit 230, and radar 235. Position estimation system 200 further comprises a sensor positioning unit 260. In alternative embodiments, the components illustrated in FIG. 2 may be combined, separated, omitted, rearranged, and/or otherwise altered, depending on desired functionality. Moreover, in alternative embodiments, position/relative pose estimation may be determined using additional or alternative data and/or data sources. For example, sensors 205 may include one or more additional or alternative sensors (e.g., lidar, sonar, etc.). One or more components of the position estimation system 200 may be implemented in hardware and/or software, such as one or more hardware and/or software components of UE 600 illustrated in FIG. 6 and described in more detail below. For example, sensor positioning unit 260 may be implemented by one or more processing units. The various hardware and/or software components that implement the position estimation system 200 may be distributed at various different locations on a vehicle, depending on desired functionality.

Wireless transceiver(s) 225 may comprise one or more RF transceivers (e.g., Wi-Fi transceiver, Wireless Wide Area Network (WWAN) or cellular transceiver, Bluetooth transceiver, etc.) for receiving positioning data from various terrestrial positioning data sources. These terrestrial positioning data sources may include, for example, Wi-Fi Access Points (APs) (Wi-Fi signals including Dedicated Source Range Communications (DSRC) signals), cellular base stations (e.g., cellular-based signals such as Positioning Reference Signals (PRS) or signals communicated via Vehicle-to-Everything (V2X), cellular V2X (CV2X), or Long-Term Evolution (LTE) direct protocols, etc.), and/or other positioning sources such as roadside units (RSUs), etc. Wireless transceiver(s) 225 also may be used for wireless communication (e.g., via Wi-Fi, cellular, etc.), in which case wireless transceiver(s) 225 may be incorporated into a wireless communication interface of the vehicle.

GNSS unit 230 may comprise a GNSS receiver and GNSS processing circuitry configured to receive signals from GNSS satellites (e.g., satellites 120) and GNSS-based positioning data. The positioning data output by the GNSS unit 230 can vary, depending on desired functionality. In some embodiments, the GNSS unit 230 may provide, among other things, a three-degrees-of-freedom (3-DOF) position determination (e.g., latitude, longitude, and altitude). Additionally or alternatively, the GNSS unit 230 can output the underlying satellite measurements used to make the 3-DOF position determination. Additionally, or alternatively, the GNSS unit can output raw measurements, such as pseudo-range and carrier-phase measurements.

Camera(s) 210 may comprise one or more cameras disposed on or in the vehicle, configured to capture images, from the perspective of the vehicle, to help track movement of the vehicle. The camera(s) 210 may be front-facing, upward-facing, backward-facing, downward-facing, and/or otherwise positioned on the vehicle. Other aspects of the camera(s) 210, such as resolution, optical band (e.g., visible light, infrared (IR), etc.), frame rate (e.g., 30 frames per second (FPS)), and the like, may be determined based on desired functionality. Movement of vehicle 110 may be tracked and information of one or more reference objects (e.g., vehicle 150) may be obtained from images captured by the camera(s) 210 using various image processing techniques to determine motion blur, object tracking, and the like, as well as information described in detail below. The raw images and/or information resulting therefrom may be passed to the sensor positioning unit 260, which may perform visual inertial odometry (VIO) using the data from both camera(s) 210 and IMU 220.

IMU 220 may comprise one or more accelerometers, gyroscopes, and/or (optionally) other sensors, such as magnetometers, to provide inertial measurements. Similar to the camera(s) 210, the output of IMU 220 to the sensor positioning unit 260 may vary, depending on desired functionality. In some embodiments, the output of IMU 220 may comprise information indicative of a 3-DOF position or 6-DOF pose of the vehicle 110, and/or a 6-DOF linear and angular velocities of vehicle 110, and may be provided periodically, based on a schedule, and/or in response to a triggering event. The position information may be relative to an initial or reference position. Alternatively, IMU 220 may provide raw sensor measurements.

Radar 235 may comprise one or more radar sensors disposed in or on the vehicle. Similar to the camera(s) 210, radar may be front-facing, upward-facing, backward-facing, downward-facing, and/or otherwise positioned on the vehicle to gather information regarding the vehicle's surroundings. According to some embodiments, a radar may scan an area or volume near the vehicle at a rate of once every second or more, or several times per second (e.g., 5, 10, 20, 50, or 100 times per second, for example), and this scan rate may be dynamic, depending on sensor capability, processing capabilities, traffic conditions, etc. Radar scans may also be referred to herein as “frames.” Radar can complement other sensors to help provide robust autonomous features. For example, enabling autonomous driving in the true sense may require robust solutions for localization in all types of weather and environmental conditions, such that a vehicle knows its pose within a few centimeters. Just like the human eye, a lidar and camera cannot see when there is too much fog in the surroundings. Global positioning sensors like GNSS may not be available in underground, or tunnel scenarios and may be challenged in urban canyon scenarios. In some embodiments, radar sensors may utilize lower frequencies, for instance using millimeter wave (mmWave) radar (e.g., having frequencies in the range of 30 GHz-300 GHz), for enabling sub-meter-level accuracy localization in such challenging scenarios.

Sensor positioning unit 260 may comprise a module (implemented in software and/or hardware) that is configured to fuse data from the sensors 205 to determine a position and/or relative pose estimate of the vehicle. As noted, the sensor positioning unit 260 may perform VIO by combining data received from camera(s) 210 and IMU 220. Sensor positioning unit 260 may utilize data from the GNSS unit 230, radar 235, and/or wireless transceiver(s) 225 in addition or as an alternative to VIO data to determine a position and/or relative pose estimate of the vehicle and/or modify a determined position and/or relative pose of the vehicle. In some embodiments, data from different sensors may be given different weights based on input type, a confidence metric (or other indication of the reliability of the input), and the like. Generally put, sensor positioning unit 260 may output an estimated position and/or relative pose estimate of the vehicle based on received inputs. Depending on the accuracy of the received inputs (e.g., accuracy of the data from sensors 205, the output of sensor positioning unit 260 may comprise one or more vehicle position estimates and/or relative pose estimates (reference frames as disclosed herein after) to facilitate autonomous vehicle navigation of vehicle 110.

As previously noted, the position and/or relative pose estimate provided by sensor positioning unit 260 may serve any of a variety of functions, depending on desired functionality. For example, it may be provided to autonomous driving, ADAS, and/or other systems of vehicle 110 (and may be conveyed via a controller area network (CAN) bus), communicated to devices separate from vehicle 110 (including other vehicles; servers maintained by government agencies, service providers, and the like; etc.), shown on a display of the vehicle (e.g., to a driver or other user for navigation or other purposes), and the like.

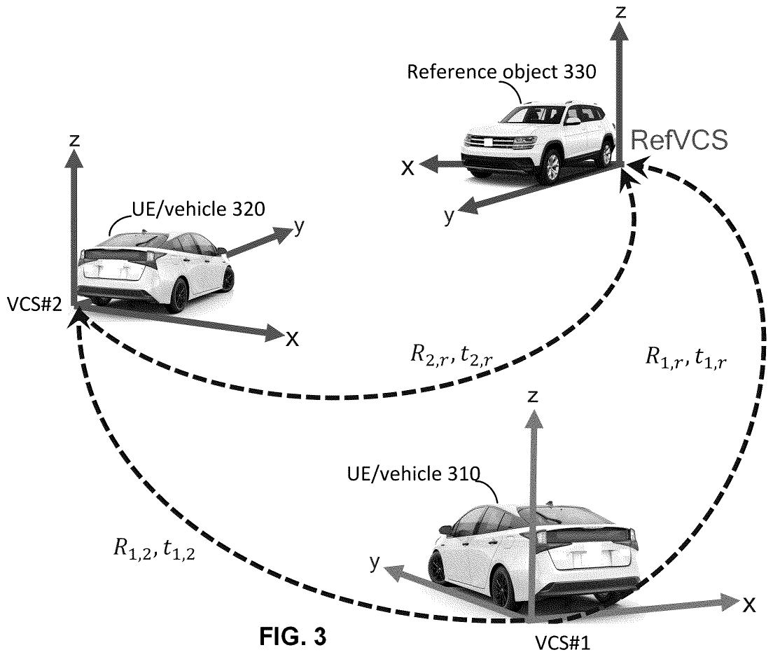

FIG. 3 is a diagram showing an example of how relative pose estimation for autonomous vehicle navigation may be performed based on opportunistic reference coordinate system, according to some embodiments. A UE/vehicle 310 may include a first UE (not shown) associated with a target vehicle (e.g., the vehicle that performs autonomous driving based on relative pose(s) estimate with respect to objects (e.g., other vehicles) within a vicinity of the target vehicle). The target vehicle may correspond to vehicle 110 in FIG. 1. Similarly, UE/vehicle 320 may include a second UE (not shown) associated with a vehicle within the vicinity of the target vehicle and may correspond to vehicle 140 in FIG. 1.

As noted above, autonomous driving may be performed based on determining the relative pose estimate of the target vehicle with respect to other vehicle(s) within its vicinity. For ease of representation and/or computation, in some embodiments, the relative poses between the vehicles may be represented by relative relationships between coordinate systems associated with the vehicles. For example, as shown in FIG. 3, UE/vehicle 310 and UE/vehicle 320 may be associated with coordinate systems #1 and #2 respectively, and the relative pose between UE/vehicle 310 and UE/vehicle 320 may be represented by the relative relationship between coordinate systems associated with UE/vehicle 310 and UE/vehicle 320 respectively.

In some embodiments, when associating a coordinate system with the corresponding vehicle, the respective coordinate system may be defined by its origin and three (orthogonal) axis and how the axes are positioned/oriented with respect to the respective vehicle. For instance, as depicted in FIG. 3, the origins of coordinate systems #1 and #2 may be situated at the rear, bottom, left end of the corresponding vehicles (e.g., UE/vehicle 310 and UE/vehicle 320 respectively), with the axes oriented in alignment with the vehicle's dimensions. It is noted that the definitions of coordinate systems #1 and #2 relative to their respective vehicles are not limited to what is disclosed herein. Any suitable definitions may be applied, depending on desired functionality.

In some embodiments, the relative relationship between coordinate systems may be represented using translation (e.g., t, a three-dimension (3D) vector corresponding to the position of the origin of one coordinate system expressed in coordinates of the other coordinate system) and rotation (e.g., R, a 3×3 matrix encapsulating the rotational differences between the two coordinate systems).

In some embodiments, the relative relationship between coordinate systems may be determined using a third (a reference) coordinate system. For example, both the coordinate systems may identify their relative poses with respect to the reference coordinate system, and the relative relationship between the coordinate systems may be determined based on their relative poses with respect to the reference coordinate system. In some embodiments, the association between the reference object and the reference coordinate system may be pre-defined (e.g., if the object is a vehicle, the reference coordinate system may have its origin at the rear-right end of its 3D rectangular bounding box and the three axes are defined along the width, length, and height of the vehicle) e.g., in a specification, or be indicated in the request message which will be disclosed in detail below.

For example, as shown in FIG. 3, the relative relationship between coordinate systems #1 and #2 may be determined using reference coordinate system #3 (e.g., a reference coordinate system that both vehicles are aware of). Specifically, both UE/vehicle 310 and UE/vehicle 320 may identify their relative poses with respect to reference coordinate system #3, and the relative relationship between coordinate systems #1 and #2 may be determined using their relative poses with respect to reference coordinate system #3.

For example, assuming that x₁ and xᵣ are 3D vectors representing the position of an arbitrary point in space expressed with respect to coordinate systems #1 and reference coordinate system #3, respectively. Accordingly, coordinate systems #1 and reference coordinate system #3 may be related as:

$${x}_{1} = {R}_{1 , r} {x}_{r} + {t}_{1 , r}$$

where R_{1,r} is a 3×3 rotation matrix and t_{1,r} is a 3D translation vector. Similarly, assuming that x₂ is the 3D vector representing the position of the point in space expressed with respect to coordinate systems #2. Coordinate systems #2 and reference coordinate system #3 may be related as:

$${x}_{2} = {R}_{2 , r} {x}_{r} + {t}_{2 , r}$$

where R_{2,r} is a 3×3 rotation matrix and t_{2,r} is a 3D translation vector.

As a result, coordinate systems #1 and coordinate systems #2 may be related as:

$${x}_{1} = {R}_{1 , 2} {x}_{2} + {t}_{1 , 2} ,$$

$$where {R}_{1 , 2} = {R}_{1 , r} {R}_{2 , r}^{T} and {t}_{1 , 2} = {R}_{1 , r} {R}_{2 , r}^{T} {t}_{2 , r} + {t}_{1 , r} .$$

Assume that R_{1,r}, t_{1,r} are known by the first UE and R_{2,r}, t_{2,r} are known by the second UE, the relative relationship between coordinate systems #1 and #2, R_{1,2} and t_{1,2}, may be determined accordingly. As a result, the relative pose estimate may be represented.

For example, when determine the relative pose estimate between UE/vehicle 310 and UE/vehicle 320, as noted above, a reference object 330 observable to both UE/vehicle 310 and UE/vehicle 320 (e.g., in the field of view of camera(s) on the vehicle) and the associated reference coordinate system #3 may be used. For example, the information of reference object 330 may be captured by sensors on the vehicle (e.g., extracted from image(s) of reference object 330 obtained by camera(s)). By using position estimation system 200 disclosed with respect to FIG. 2, the first UE may determine a first relative pose of UE/vehicle 310 with respect to reference coordinate system #3 (e.g., R_{1,r}, t_{1,r}), and the second UE may determine a second relative pose of UE/vehicle 320 with respect to reference coordinate system #3 (e.g., R_{2,r}, t_{2,r}) accordingly. As will be disclosed in detail below, the second UE may share R_{2,r}, t_{2,r} with the first UE responsive to receiving a request message (e.g., transmitted using unicast sidelink or broadcast sidelink, on a need-to-know basis). As a result, the first UE may determine the relative pose estimate of UE/vehicle 310 with respect to UE/vehicle 320 based on R_{1,r}, t_{1,r}, R_{2,r}, and t_{2,r}, according to the technical scheme disclosed above.

It is noted that in some embodiments, the rotation R (e.g., R_{1,r} R_{2,r} and/or R_{1,2}) disclosed herein may also be represented using three elements of axis-angle representation of rotation. Additionally or alternatively, responsive to the UE/vehicle 310, UE/vehicle 320, and reference object 330 are on a horizontal plane, the rotation R may be represented using a single angular value of rotation.

It is noted that although as shown in FIG. 3, reference object 330 includes a vehicle (e.g., corresponding to vehicle 150 in FIG. 1), other reference objects such as roadside units, road marks, buildings, traffic lights, etc. may also be used as the one or more of the reference objects. In some embodiments, reference object 330 may be described (e.g., extracted from the image(s) obtained by the camera(s)) using image descriptors e.g., in a request and/or response message. Additionally or alternatively, in case where reference object 330 includes a vehicle, reference object 330 may be described using one or more visual characters of the vehicle such as the license plate, the model, the color, or any combination thereof.

In some embodiments, as will be disclosed in detail below, more than one reference objects each labeled with a respective reference identification (ID) may be used for determining the relative pose estimate to increase the robustness of the relative pose estimation. For example, the first UE may determine the relative poses of UE/vehicle 310 with respect to more than one reference objects (e.g., pairs of rotation and translation values) observable to UE/vehicle 310 (e.g., in the field of view of camera(s) on the vehicle), label the more than one reference objects with different IDs, and indicate the more than one reference objects (e.g., using the different IDs) to the second UE in a request message transmitted to the second UE. The second UE may determine the relative poses of UE/vehicle 320 with respect to more than one reference objects indicated in the request message and may indicate the relative poses with respect to the more than one reference objects in a response message transmitted to the first UE. The first UE may determine the relative pose estimate between UE/vehicle 310 and UE/vehicle 320 based on each of the used reference objects according to the technical schemes disclosed above.

By using more than one reference objects, the possibility that at least one of the reference objects is observable to both UE/vehicle 310 and UE/vehicle 320 may be increased. Additionally, by using more than one reference objects observable to both UE/vehicle 310 and UE/vehicle 320 for determining the relative pose between the UE/vehicle 310 and UE/vehicle 320, the accuracy of the estimate may be increased.

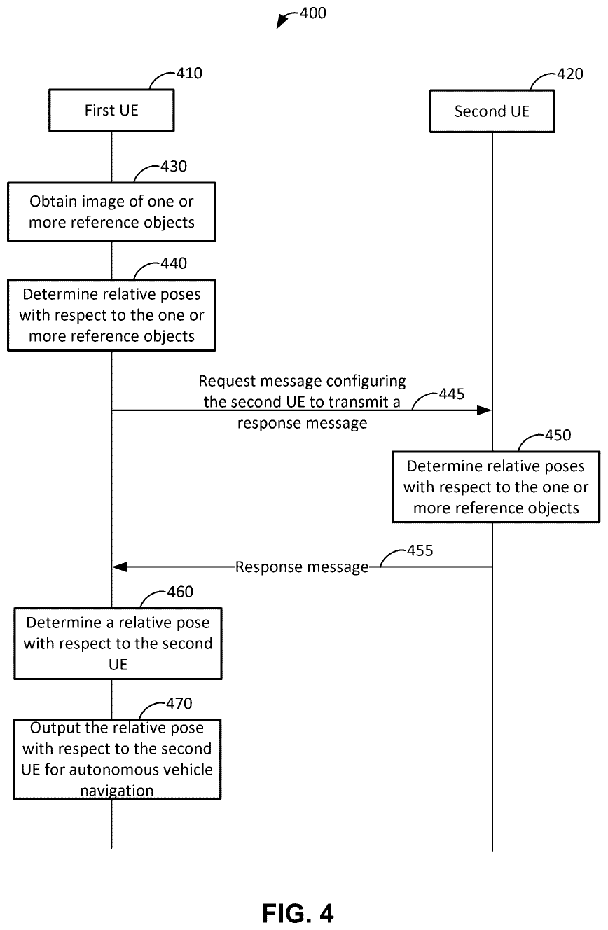

FIG. 4 is a call diagram showing an example of how relative pose estimation 400 for autonomous vehicle navigation may be performed among different UEs, according to some embodiments. As shown in FIG. 4, relative pose estimation 400 may be performed between a first UE 410 and a second UE 420. In some embodiments, first UE 410 may be associated with a first vehicle (e.g., corresponding to vehicle 110 in FIG. 1) and the association may correspond to the first UE of UE/vehicle 310 in FIG. 3. Second UE 420 may be associated with a second vehicle (e.g., corresponding to vehicle 140 in FIG. 1) and the association may correspond to UE/vehicle 320 in FIG. 3.

Starting at block 430, first UE 410 may obtain the information of one or more reference objects (e.g., images of reference object 330 in FIG. 3) using sensors (e.g., camera(s)) on the first vehicle. As noted above, the one or more reference objects may be any suitable set of one or more objects that is observable to the camera(s) on the first vehicle (e.g., in the field of view of the camera(s)). For example, the one or more reference objects may include a vehicle (e.g., corresponding to vehicle 150 in FIG. 1), or other reference objects such as roadside units, road marks, buildings, traffic lights, etc. In some embodiments, the one or more reference objects may be described (e.g., extracted from the image(s) obtained by the camera(s)) using image descriptors e.g., in a request and/or response message. Additionally or alternatively, in case where the one or more reference objects include a vehicle, the reference object may be described using one or more visual characters of the vehicle such as the license plate, the model, the color, or any combination thereof.

At block 440, first UE 410 may determine relative poses of the first vehicle with respect to the one or more reference objects based on e.g., the images of the one or more reference objects obtained by the camera(s). As noted above, first UE 410 may use position estimation system 200 disclosed with respect to FIG. 2 for determining relative poses of the first vehicle with respect to the reference coordinate systems associated with the one or more reference objects.

At arrow 445, a request message may be transmitted to second UE 420 configuring second UE 420 to transmit a response message. In some embodiments, the one or more reference objects may be indicated in the request message, each of which is labeled with a respective reference ID. As noted above, the request message may indicate image descriptors of each of the one or more reference objects. Additionally or alternatively, in the case where the one or more reference objects include a vehicle, the request message may indicate one or more visual characters of the vehicle, such as a license plate, a model, a color, or any combination thereof.

In some embodiments, information regarding how the reference coordinate system (e.g., reference coordinate system #3 in FIG. 3) is associated with the reference object may be indicated in the request message in cases where the association may not be pre-defined (e.g., in a specification or a standard).

In some embodiments, optionally, the request message may also include the relative poses of the first vehicle with respect to the one or more reference objects, so that second UE 420 may also calculate the relative pose estimate of the second vehicle with respect to the first vehicle in a later process.

A block 450, responsive to receiving the request message, second UE 420 may determine relative poses of the second vehicle with respect to the one or more reference objects observable to second UE 420 (e.g., in the field of view of camera(s) on the second vehicle). The relative poses may be determined based on e.g., the images of the one or more reference objects obtained by the camera(s) on the second vehicle. As noted above, second UE 420 may use position estimation system 200 disclosed with respect to FIG. 2 for determining relative poses of the second vehicle with respect to the reference coordinate systems associated with the one or more reference objects.

At arrow 455, a response message may be transmitted to first UE 410 responsive to receiving the request message, indicating the relative poses of the second vehicle with respect to the one or more reference objects. In some embodiments, the response message may include different pairs of rotation and translation values representing relative poses with respect to different reference coordinate systems. The response message may also include how the coordinate system (e.g., coordinate system #2 in FIG. 3) is associated with the second vehicle in case where the association may not be pre-defined (e.g., in a specification or a standard).

In some embodiments, the response message may include a timestamp for each of the determined relative poses (e.g., when the relative pose is determined), an accuracy of the relative poses, or any combination thereof. For example, the accuracy of the relative pose may be represented in the form of maximum expected deviation of reported values from the ground truth.

In some embodiments, the request message and/or the response message may be transmitted using unicast sidelinks or broadcast sidelinks, e.g., on a need-to-know basis. For example, the request message may include a (sidelink) unicast message if the second UE is explicitly identified and of known UE ID. Additionally or alternatively, the message may be (sidelink) broadcast or groupcast, if more than one responses may be solicitated (e.g., determining relative poses estimate with respect to multiple vehicles within the vicinity of the target vehicle) or it is uncertain whether a single UE will be able to respond the request message.

It is noted that although only one second UE 420 is shown in FIG. 4 and only one UE/vehicle 320 is shown in FIG. 3, the existence and number of UEs that can respond to the request message (e.g., the number of second UE 420 and/or UE/vehicle 320) may not be limited. In some embodiments, the existence and number of UEs that can respond to the request message may depend on the UEs that know their relative poses with respect to the indicated reference object(s) identified in the request message.

A block 460, based on the relative pose(s) indicated in the response message, first UE 410 may determine a relative pose of the first vehicle with respect to the second vehicle according to the technical scheme disclosed above (e.g., according to the description with respect to FIG. 3).

A block 470, the relative pose of the first vehicle with respect to the second vehicle may be output to e.g., an application for autonomous vehicle navigation of the first vehicle.

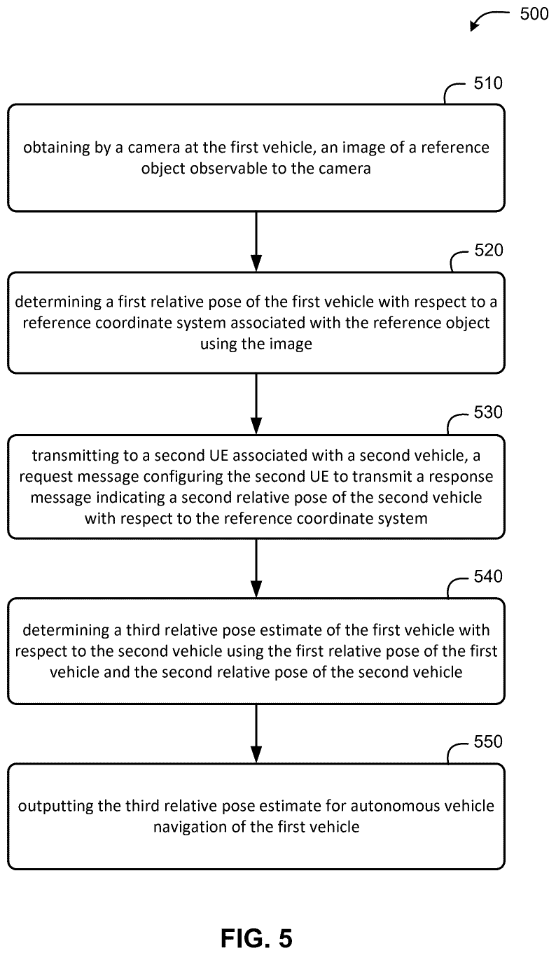

FIG. 5 is a flow diagram of a method 500 of relative pose estimation for autonomous vehicle navigation based on opportunistic reference coordinate system, according to an embodiment. In some embodiments, the method 500 may be performed by an UE which may correspond to the UE of UE/vehicle 310 in FIG. 3 and first UE 410 in FIG. 4. Means for performing the functionality illustrated in one or more of the blocks shown in FIG. 5 may be performed by hardware and/or software components of a UE. Example components of a UE are illustrated in FIG. 6, which is described in more detail below.

At block 510, the functionality comprises obtaining by a camera at the first vehicle, an image of a reference object observable to the camera. As noted above, the first UE may obtain the information of one or more reference objects (e.g., images of reference object 330 in FIG. 3) using sensors (e.g., camera(s)) on the first vehicle. As noted above, the one or more reference objects may be any suitable objects that is observable to the camera(s) on the first vehicle (e.g., in the field of view of the camera(s)). For example, the one or more reference objects may include a vehicle (e.g., corresponding to vehicle 150 in FIG. 1), or other reference objects such as roadside units, road marks, buildings, traffic lights, etc.

In some embodiments, the one or more reference objects may be described (e.g., extracted from the image(s) obtained by the camera(s)) using image descriptors e.g., in a request and/or response message. Additionally or alternatively, in case where the one or more reference objects include a vehicle, the reference object may be described using one or more visual characters of the vehicle such as the license plate, the model, the color, or any combination thereof.

Means for performing functionality at block 510 may comprise a bus 605, processor(s) 610, wireless communication interface 630, memory 660, and/or other components of a UE 600, as illustrated in FIG. 6.

At block 520, the functionality comprises determining a first relative pose of the first vehicle with respect to a reference coordinate system associated with the reference object using the image. For example, the first UE may determine relative poses of the first vehicle with respect to the one or more reference objects based on e.g., the images of the one or more reference objects obtained by the camera(s). As noted above, the first UE may use position estimation system 200 disclosed with respect to FIG. 2 for determining relative poses of the first vehicle with respect to the reference coordinate systems associated with the one or more reference objects.

Means for performing functionality at block 520 may comprise a bus 605, processor(s) 610, wireless communication interface 630, memory 660, and/or other components of a UE 600, as illustrated in FIG. 6.

At block 530, the functionality comprises transmitting to a second UE associated with a second vehicle, a request message configuring the second UE to transmit a response message indicating a second relative pose of the second vehicle with respect to the reference coordinate system. In some embodiments, the one or more reference objects may be indicated in the request message, each of which is labeled with a respective reference ID. As noted above, the request message may indicate image descriptors of each of the one or more reference objects. Additionally or alternatively, in case where the one or more reference objects include a vehicle, the request message may indicate one or more visual characters of the vehicle, such as a license plate, a model, a color, or any combination thereof.

In some embodiments, information regarding how the reference coordinate system (e.g., reference coordinate system #3 in FIG. 3) is associated with the reference object may be indicated in the request message in case where the association may not be pre-defined (e.g., in a specification or a standard).

In some embodiments, optionally, the request message may also include the relative poses of the first vehicle with respect to the one or more reference objects, so that second UE 420 may also calculate the relative pose estimate of the second vehicle with respect to the first vehicle in later process.

In some embodiments, the request message and/or the response message may be transmitted using unicast sidelinks or broadcast sidelinks, on a need-to-know basis. For example, the request message may include a (sidelink) unicast message if the second UE is explicitly identified and of known UE ID. Additionally or alternatively, the message may be (sidelink) broadcast or groupcast, if more than one responses may be solicitated (e.g., determining relative poses estimate with respect to multiple vehicles within the vicinity of the target vehicle) or it is uncertain whether a single UE will be able to respond the request message.

In some embodiments, the response message may include a timestamp for each of the determined relative poses (e.g., when the relative pose is determined), an accuracy of the relative poses, or any combination thereof. For example, the accuracy of the relative pose may be represented in the form of maximum expected deviation of reported values from the ground truth.

Means for performing functionality at block 530 may comprise a bus 605, processor(s) 610, wireless communication interface 630, memory 660, and/or other components of a UE 600, as illustrated in FIG. 6.

At block 540, the functionality comprises determining a third relative pose estimate of the first vehicle with respect to the second vehicle using the first relative pose of the first vehicle and the second relative pose of the second vehicle. For example, the determination may be performed according to the description with respect to FIG. 3.

Means for performing functionality at block 540 may comprise a bus 605, processor(s) 610, wireless communication interface 630, memory 660, and/or other components of a UE 600, as illustrated in FIG. 6.

At block 550, the functionality comprises outputting the third relative pose estimate for autonomous vehicle navigation of the first vehicle. For example, the third relative pose estimate may be used for applications such as planning future paths, avoiding collisions, implementing emergency maneuvers, etc.

Means for performing functionality at block 550 may comprise a bus 605, processor(s) 610, wireless communication interface 630, memory 660, and/or other components of a UE 600, as illustrated in FIG. 6.

FIG. 6 is a block diagram of an embodiment of a UE 600, which can be utilized as described herein above (e.g., in association with FIGS. 2-5). For example, the UE 600 can perform one or more of the functions of the method shown in FIG. 5. It should be noted that FIG. 6 is meant only to provide a generalized illustration of various components, any or all of which may be utilized as appropriate. It can be noted that, in some instances, components illustrated by FIG. 6 can be localized to a single physical device and/or distributed among various networked devices, which may be disposed at different physical locations. Furthermore, as previously noted, the functionality of the UE discussed in the previously described embodiments may be executed by one or more of the hardware and/or software components illustrated in FIG. 6.

The UE 600 is shown comprising hardware elements that can be electrically coupled via a bus 605 (or may otherwise be in communication, as appropriate). The hardware elements may include a processor(s) 610 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 610 may comprise one or more processing units, which may be housed in a single integrated circuit (IC) or multiple ICs. As shown in FIG. 6, some embodiments may have a separate DSP 620, depending on desired functionality. Location determination and/or other determinations based on wireless communication may be provided in the processor(s) 610 and/or wireless communication interface 630 (discussed below). The UE 600 also can include one or more input devices 670, which can include without limitation one or more keyboards, touch screens, touch pads, microphones, buttons, dials, switches, cameras, and/or the like; and one or more output devices 615, which can include without limitation one or more displays (e.g., touch screens), light emitting diodes (LEDs), speakers, and/or the like.

The UE 600 may also include a wireless communication interface 630, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the UE 600 to communicate with other devices as described in the embodiments above. The wireless communication interface 630 may permit data and signaling to be communicated (e.g., transmitted and received) with TRPs of a network, for example, via eNBs, gNBs, ng-eNBs, access points, various base stations and/or other access node types, and/or other network components, computer systems, and/or any other electronic devices communicatively coupled with TRPs, as described herein. The communication can be carried out via one or more wireless communication antenna(s) 632 that send and/or receive wireless signals 634. According to some embodiments, the wireless communication antenna(s) 632 may comprise a plurality of discrete antennas, antenna arrays, or any combination thereof. The antenna(s) 632 may be capable of transmitting and receiving wireless signals using beams (e.g., Tx beams and Rx beams). Beam formation may be performed using digital and/or analog beam formation techniques, with respective digital and/or analog circuitry. The wireless communication interface 630 may include such circuitry.

Depending on desired functionality, the wireless communication interface 630 may comprise a separate receiver and transmitter, or any combination of transceivers, transmitters, and/or receivers to communicate with base stations (e.g., ng-eNBs and gNBs) and other terrestrial transceivers, such as wireless devices and access points. The UE 600 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The UE 600 can further include sensor(s) 640. Sensor(s) 640 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), camera(s), and the like), some of which may be used to obtain position-related measurements and/or other information.

Embodiments of the UE 600 may also include a Global Navigation Satellite System (GNSS) receiver 680 capable of receiving signals 684 from one or more GNSS satellites using an antenna 682 (which could be the same as antenna 632). Positioning based on GNSS signal measurement can be utilized to complement and/or incorporate the techniques described herein. The GNSS receiver 680 can extract a position of the UE 600, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 680 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 680 is illustrated in FIG. 6 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 610, DSP 620, and/or a processor within the wireless communication interface 630 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), particle filter, or the like. The positioning engine may also be executed by one or more processors, such as processor(s) 610 or DSP 620.

The UE 600 may further include and/or be in communication with a memory 660. The memory 660 can include, without limitation, local and/or network accessible storage, a disk drive, a drive array, an optical storage device, a solid-state storage device, such as a random-access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 660 of the UE 600 also can comprise software elements (not shown in FIG. 6), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 660 that are executable by the UE 600 (and/or processor(s) 610 or DSP 620 within UE 600). In some embodiments, then, such code and/or instructions can be used to configure and/or adapt a general-purpose computer (or other device) to perform one or more operations in accordance with the described methods.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

Clause 1. An example method of relative pose estimation for autonomous vehicle navigation performed by a first User Equipment (UE) associated with a first vehicle may comprise obtaining by a camera at the first vehicle, an image of a reference object observable to the camera and determining a first relative pose of the first vehicle with respect to a reference coordinate system associated with the reference object using the image. The method may comprise transmitting to a second UE associated with a second vehicle, a request message configuring the second UE to transmit a response message indicating a second relative pose of the second vehicle with respect to the reference coordinate system and determining a third relative pose estimate of the first vehicle with respect to the second vehicle using the first relative pose of the first vehicle and the second relative pose of the second vehicle. The method may comprise outputting the third relative pose estimate for autonomous vehicle navigation of the first vehicle.

Clause 2. The method of clause 1, wherein the response message indicates: a timestamp for a determination of the second relative pose; accuracy of the determination of the second relative pose; or any combination thereof.

Clause 3. The method of any of clause 1 or 2, wherein the request message indicates the first relative pose of the first vehicle with respect to the reference coordinate system.

Clause 4. The method of any of clauses 1-3, wherein the request message indicates image descriptors of the reference object.

Clause 5. The method of any of clauses 1-4, wherein the reference object comprises a third vehicle, wherein the request message indicates: one or more visual characters of the third vehicle comprising: a license plate; a model; a color; or any combination thereof.

Clause 6. The method of any of clauses 1-5, wherein the request message is transmitted using sidelink unicast transmission.

Clause 7. The method of any of clauses 1-6, wherein the request message is transmitted using sidelink groupcast messages or sidelink broadcast transmission.

Clause 8. The method of any of clauses 1-7, wherein the third relative pose estimate comprises a relative rotation of the first vehicle and a relative translation of the first vehicle with respect to the second vehicle.

Clause 9. The method of any of clauses 1-8, wherein the relative rotation of the first vehicle is represented using nine real-valued elements or three elements of axis-angle representation of rotation.

Clause 10. The method of any of clauses 1-9, wherein responsive to the first vehicle, the second vehicle, and the reference object are on a horizontal plane, the relative rotation of the first vehicle is represented using a single angular value of rotation.

Clause 11. The method of any of clauses 1-10, wherein the third relative pose estimate is defined in a vehicle coordinate system associated with the first vehicle.

Clause 12. The method of any of clauses 1-11, wherein the request message indicates a plurality of reference objects, each labeled with a respective reference identification.

Clause 13. An example User Equipment (UE) for relative pose estimation for autonomous vehicle navigation, wherein the UE is associated with a first vehicle, and wherein the UE comprises a transceiver, a memory, and one or more processors communicatively coupled with the transceiver and the memory. The one or more processors may be configured to obtain by a camera at the first vehicle, an image of a reference object observable to the camera. The one or more processors may be configured to determine a first relative pose of the first vehicle with respect to a reference coordinate system associated with the reference object using the image. The one or more processors may be configured to transmit to a second UE associated with a second vehicle, a request message configuring the second UE to transmit a response message indicating a second relative pose of the second vehicle with respect to the reference coordinate system. The one or more processors may be configured to determine a third relative pose estimate of the first vehicle with respect to the second vehicle using the first relative pose of the first vehicle and the second relative pose of the second vehicle. The one or more processors may be configured to output the third relative pose estimate for autonomous vehicle navigation of the first vehicle.

Clause 14. The UE of clause 13, wherein the response message indicates: a timestamp for a determination of the second relative pose; accuracy of the determination of the second relative pose; or any combination thereof.

Clause 15. The UE of any of clause 13 or 14, wherein the request message indicates the first relative pose of the first vehicle with respect to the reference coordinate system.

Clause 16. The UE of any of clauses 13-15, wherein the request message indicates image descriptors of the reference object.

Clause 17. The UE of any of clauses 13-16, wherein the reference object comprises a third vehicle, wherein the request message indicates: one or more visual characters of the third vehicle comprising: a license plate; a model; a color; or any combination thereof.

Clause 18. The UE of any of clauses 13-17, wherein the request message is transmitted using sidelink unicast transmission.

Clause 19. The UE of any of clauses 13-18, wherein wherein the request message is transmitted using sidelink groupcast messages or sidelink broadcast transmission.

Clause 20. The UE of any of clauses 13-19, wherein the third relative pose estimate comprises a relative rotation of the first vehicle and a relative translation of the first vehicle with respect to the second vehicle.

Clause 21. The UE of any of clauses 13-20, wherein the relative rotation of the first vehicle is represented using nine real-valued elements or three elements of axis-angle representation of rotation.

Clause 22. The UE of any of clauses 13-21, wherein responsive to the first vehicle, the second vehicle, and the reference object are on a horizontal plane, the relative rotation of the first vehicle is represented using a single angular value of rotation.

Clause 23. The UE of any of clauses 13-22, wherein the third relative pose estimate is defined in a vehicle coordinate system associated with the first vehicle.

Clause 24. The UE of any of clauses 13-23, wherein the request message indicates a plurality of reference objects, each labeled with a respective reference identification.

Clause 25. An example apparatus for relative pose estimation for autonomous vehicle navigation, the apparatus may comprise means for obtaining by a camera at a first vehicle associated with the apparatus, an image of a reference object observable to the camera. The apparatus may comprise means for determining a first relative pose of the first vehicle with respect to a reference coordinate system associated with the reference object using the image. The apparatus may comprise means for transmitting to a second UE associated with a second vehicle, a request message configuring the second UE to transmit a response message indicating a second relative pose of the second vehicle with respect to the reference coordinate system. The apparatus may comprise means for determining a third relative pose estimate of the first vehicle with respect to the second vehicle using the first relative pose of the first vehicle and the second relative pose of the second vehicle. The apparatus may comprise means for outputting the third relative pose estimate for autonomous vehicle navigation of the first vehicle.

Clause 26. The apparatus of clause 25, wherein the response message indicates: a timestamp for a determination of the second relative pose; accuracy of the determination of the second relative pose; or any combination thereof.

Clause 27. The apparatus of any of clause 25 or 26, wherein the request message indicates the first relative pose of the first vehicle with respect to the reference coordinate system.

Clause 28. The apparatus of any of clauses 25-27, wherein the request message indicates image descriptors of the reference object.

Clause 29. The apparatus of any of clauses 25-28, wherein the reference object comprises a third vehicle, wherein the request message indicates: one or more visual characters of the third vehicle comprising: a license plate; a model; a color; or any combination thereof.

Clause 30. An example non-transitory computer-readable medium storing instructions for relative pose estimation for autonomous vehicle navigation, the instructions may comprise code for obtaining by a camera at the first vehicle, an image of a reference object observable to the camera. The instructions may comprise code for determining a first relative pose of the first vehicle with respect to a reference coordinate system associated with the reference object using the image. The instructions may comprise code for transmitting to a second UE associated with a second vehicle, a request message configuring the second UE to transmit a response message indicating a second relative pose of the second vehicle with respect to the reference coordinate system. The instructions may comprise code for determining a third relative pose estimate of the first vehicle with respect to the second vehicle using the first relative pose of the first vehicle and the second relative pose of the second vehicle. The instructions may comprise code for outputting the third relative pose estimate for autonomous vehicle navigation of the first vehicle.

1. A method of relative pose estimation for autonomous vehicle navigation, the method performed by a first User Equipment (UE) associated with a first vehicle and comprising:
obtaining by a camera at the first vehicle, an image of a reference object observable to the camera;
determining a first relative pose of the first vehicle with respect to a reference coordinate system associated with the reference object using the image;
transmitting to a second UE associated with a second vehicle, a request message configuring the second UE to transmit a response message indicating a second relative pose of the second vehicle with respect to the reference coordinate system;
determining a third relative pose estimate of the first vehicle with respect to the second vehicle using the first relative pose of the first vehicle and the second relative pose of the second vehicle; and
outputting the third relative pose estimate for autonomous vehicle navigation of the first vehicle.

2. The method of claim 1, wherein the response message indicates:
a timestamp for a determination of the second relative pose;
accuracy of the determination of the second relative pose; or
any combination thereof.

3. The method of claim 1, wherein the request message indicates the first relative pose of the first vehicle with respect to the reference coordinate system.

4. The method of claim 1, wherein the request message indicates image descriptors of the reference object.

5. The method of claim 1, wherein the reference object comprises a third vehicle, wherein the request message indicates:
one or more visual characters of the third vehicle comprising:
a license plate;
a model;
a color; or
any combination thereof.

6. The method of claim 1, wherein the request message is transmitted using sidelink unicast transmission.

7. The method of claim 1, wherein the request message is transmitted using sidelink groupcast messages or sidelink broadcast transmission.

8. The method of claim 1, wherein the third relative pose estimate comprises a relative rotation of the first vehicle and a relative translation of the first vehicle with respect to the second vehicle.

9. The method of claim 8, wherein the relative rotation of the first vehicle is represented using nine real-valued elements or three elements of axis-angle representation of rotation.

10. The method of claim 8, wherein responsive to the first vehicle, the second vehicle, and the reference object are on a horizontal plane, the relative rotation of the first vehicle is represented using a single angular value of rotation.

11. The method of claim 1, wherein the third relative pose estimate is defined in a vehicle coordinate system associated with the first vehicle.

12. The method of claim 1, wherein the request message indicates a plurality of reference objects, each labeled with a respective reference identification.

13. A User Equipment (UE) for relative pose estimation for autonomous vehicle navigation, wherein the UE is associated with a first vehicle, and wherein the UE comprises:
a transceiver;
a memory; and
one or more processors communicatively coupled with the transceiver and the memory, wherein the one or more processors are configured to:
obtain by a camera at the first vehicle, an image of a reference object observable to the camera;
determine a first relative pose of the first vehicle with respect to a reference coordinate system associated with the reference object using the image;
transmit to a second UE associated with a second vehicle, a request message configuring the second UE to transmit a response message indicating a second relative pose of the second vehicle with respect to the reference coordinate system;
determine a third relative pose estimate of the first vehicle with respect to the second vehicle using the first relative pose of the first vehicle and the second relative pose of the second vehicle; and
output the third relative pose estimate for autonomous vehicle navigation of the first vehicle.

14. The UE of claim 13, wherein the response message indicates:
a timestamp for a determination of the second relative pose;
accuracy of the determination of the second relative pose; or
any combination thereof.

15. The UE of claim 13, wherein the request message indicates the first relative pose of the first vehicle with respect to the reference coordinate system.

16. The UE of claim 13, wherein the request message indicates image descriptors of the reference object.

17. The UE of claim 13, wherein the reference object comprises a third vehicle, wherein the request message indicates:
one or more visual characters of the third vehicle comprising:
a license plate;
a model;
a color; or
any combination thereof.

18. The UE of claim 13, wherein the request message is transmitted using sidelink unicast transmission.

19. The UE of claim 13, wherein the request message is transmitted using sidelink groupcast messages or sidelink broadcast transmission.

20. The UE of claim 13, wherein the third relative pose estimate comprises a relative rotation of the first vehicle and a relative translation of the first vehicle with respect to the second vehicle.

21-30. (canceled)
